(19) United States
(12) Patent Application Publication
(10) Pub. No.: US 2026/0267136 A1
(43) Pub. Date: Sep. 10, 2026

(54) SPHERICAL ABERRATION ADJUSTMENT METHOD FOR OBJECTIVE OPTICAL SYSTEM, OBJECTIVE OPTICAL SYSTEM AND LASER MACHINING DEVICE

(71) Applicant: Tokyo Seimitsu Co., Ltd., Tokyo (JP)

(72) Inventor: Kazuo KAJITANI, Tokyo (JP)

(73) Assignee: Tokyo Seimitsu Co., Ltd., Tokyo (JP)

(21) Appl. No.: 19/666,689

(22) Filed: May 4, 2026

Related U.S. Application Data
(63) Continuation of application No. 18/048,781, filed on Oct. 21, 2022.

(30) Foreign Application Priority Data
Oct. 22, 2021 (JP) 2021-173390

(51) Int. Cl. G02B 27/00; G02B 15/14

(52) U.S. Cl. CPC G02B 27/0025; G02B 15/14

(57) ABSTRACT

A spherical aberration adjustment method for an objective optical system having an objective lens, and a diopter adjusting optical system arranged on an opposite side of a medium with respect to the objective lens, including changing an emittance or convergence of a luminous flux of laser light by the diopter adjusting optical system, and changing a depth of a focal point inside the medium with a diffraction limit of the objective optical system kept.

### CROSS-REFERENCE TO RELATED APPLICATIONS

This application is a continuation of U.S. application Ser. No. 18/048,781, Oct. 21, 2022, which claims the priority benefit under 35 U.S.C. § 119 of Japanese Patent Application No. 2021-173390 filed on Oct. 22, 2021, which is hereby incorporated in its entirety by reference.

### BACKGROUND OF THE INVENTION

### Field of the Invention

The presently disclosed subject matter relates to a spherical aberration adjustment method for an objective optical system, an objective optical system and a laser machining device, and particularly relates to a technology for spherical aberration correction applicable to an objective optical system such as a condenser lens for laser machining that forms a focal point inside a medium, a microscope objective lens, or the like.

### Description of the Related Art

There is a technique for laser machining that generates laser machining region inside a workpiece by condensing light inside the workpiece instead of vicinity of a surface of the workpiece. In order to secure a condensing performance of a condenser lens for laser machining, the condensing is performed for narrowing to a diffraction limit at a focal point inside a workpiece. Also, a specimen to be observed may be observed by focusing on an internal part of the specimen under a laser microscope. The resolution of the microscope objective lens is also required to be narrowed to a diffraction limit at a focal point inside the specimen, like a case of a condenser lens for laser machining.

Since a condenser lens for laser machining and microscope objective lens are different only in direction of a light beam between the focal point and the focused focal point, a condenser lens and an objective lens are simply referred to as an objective lens, and a workpiece and a specimen to be observed through which light passes may be referred as a medium or a transparent medium, in the following description.

In a laser machining device, a light beam that is converged inside a medium has a spherical aberration that changes in accordance with the thickness of the medium through which the light beam passes (or the depth of the focal point). Therefore, in a case where the focal point is to be changed inside the medium, a spherical aberration adjusting mechanism may be provided within the condenser lens (objective lens) in order to adjust the spherical aberration due to a change in thickness of the medium through which the light beam passes. For example, Japanese Patent Application Laid-Open No. 5-119263 discloses correcting a spherical aberration caused by variations of a thickness of a cover glass in a microscope objective lens.
Patent Literature 1: Japanese Patent Application Laid-Open No. 5-119263

### SUMMARY OF THE INVENTION

By the way, in a case where the focal point is changed inside the medium, a spherical aberration occurs also on the objective lens side in addition to the spherical aberration due to the change of the thickness of the medium through which the light beam passes. Therefore, in order to secure a condensing performance or a resolution in the objective lens, the spherical aberration that occurs on the objective lens side is required to be resolved.

The presently disclosed subject matter was made in view of such circumstances, and it is an object of the presently disclosed subject matter to provide a spherical aberration adjustment method for an objective optical system, an objective optical system and a laser machining device that can keep a focal point inside a medium at a diffraction limit in a case where the focal point is moved in a direction of depth of the medium.

In order to achieve the object described above, a first aspect of the presently disclosed subject matter is a spherical aberration adjustment method for an objective optical system having an objective lens, and a diopter adjusting optical system arranged on an opposite side of a medium with respect to the objective lens, the method including changing an emittance or convergence of a luminous flux of laser light by the diopter adjusting optical system, and changing a depth of a focal point inside the medium with a diffraction limit of the objective optical system kept.

A second aspect of the presently disclosed subject matter is the spherical aberration adjustment method for the objective optical system according to the first aspect, wherein the changing the emittance or the convergence includes increasing a positive power to be given to the diopter adjusting optical system as a distance from a surface of the medium to the focal point inside the medium decreases, and increasing an absolute value of a negative power to be given to the diopter adjusting optical system as the distance from the surface of the medium to the focal point inside the medium increases.

A third aspect of the presently disclosed subject matter is the spherical aberration adjustment method for the objective optical system according to the first or second aspect, wherein the medium has a refractive index of 1.7 or higher.

A fourth aspect of the presently disclosed subject matter is an objective optical system including an objective lens, and a diopter adjusting optical system arranged on an opposite side of a medium with respect to the objective lens, the diopter adjusting optical system changing an emittance or convergence of a luminous flux of laser light and changing a depth of a focal point inside the medium with a diffraction limit kept.

A fifth aspect of the presently disclosed subject matter is the objective optical system according to the fourth aspect, wherein the diopter adjusting optical system includes one of a focal length variable lens, a transmission spatial light modulator, a deformable mirror, and a reflection spatial light modulator.

A sixth aspect of the presently disclosed subject matter is the objective optical system according to the fourth or fifth aspect, wherein the objective lens has a numerical aperture of 0.6 to 0.9.

A seventh aspect of the presently disclosed subject matter is the objective optical system according to any of the fourth to sixth aspects, further including an optical system arranged between the diopter adjusting optical system and the objective lens, the optical system relaying such that the diopter adjusting optical system is conjugate with the objective lens.

An eighth aspect of the presently disclosed subject matter is the objective optical system according to any of the fourth to seventh aspects, further including a spherical aberration adjustment mechanism that moves partial lenses within the objective lens in a direction of an optical axis and thus adjusts a spherical aberration of the objective lens.

A ninth aspect of the presently disclosed subject matter is a laser machining device including an objective optical system according to any of the fourth to eighth aspects, the objective optical system condensing laser light to a focal point inside a medium.

According to the presently disclosed subject matter, the depth of a focal point inside a medium can be changed while keeping it at a diffraction limit.

### BRIEF DESCRIPTION OF THE DRAWINGS

FIG. 1 includes side views illustrating examples of an objective optical system according to an embodiment of the presently disclosed subject matter;

FIG. 2 includes side views for explaining an example of changing a depth of a focal point;

FIG. 3 is a diagram illustrating an example of a spherical aberration due to a change of a depth of a focal point;

FIG. 4 includes light beam diagrams in a case where a distance between an objective lens and a medium is changed;

FIG. 5 is a diagram illustrating an example of a spherical aberration that occurs when a distance between an objective lens and a medium is changed;

FIG. 6 is a diagram for explaining an example of an adjustment of a spherical aberration;

FIG. 7 is a diagram illustrating an adjustment result of a spherical aberration adjustment;

FIG. 8 is a graph illustrating results of calculations of a spherical aberration when a depth of a focal point is changed in a first embodiment;

FIG. 9 illustrates light beam diagrams of Examples (a1) to (a5) illustrated in FIG. 8;

FIG. 10 is a cross-sectional view illustrating an objective lens according to the first embodiment;

FIG. 11 is a table illustrating lens data on the objective lens according to the first embodiment;

FIG. 12 is a table illustrating a correspondence relationship between a power to be given to a diopter converting element and a distance from the objective lens to a surface of a medium;

FIG. 13 is a graph illustrating spherical aberrations that occur when positive and negative powers are given to the diopter converting element;

FIG. 14 illustrates light beam diagrams of Examples (b1) to (b5) illustrated in FIGS. 12 and 13;

FIG. 15 is a graph illustrating results of adjustments of spherical aberrations according to the first embodiment;

FIG. 16 illustrates light beam diagrams of Examples (c1) to (c5) illustrated in FIG. 15;

FIG. 17 is a table illustrating Strehl ratios in Examples (c1) to (c5) illustrated in FIG. 15;

FIG. 18 is a graph illustrating results of calculations of a spherical aberration when a depth of a focal point is changed in a second embodiment;

FIG. 19 illustrates light beam diagrams of Examples (d1) to (d5) illustrated in FIG. 18;

FIG. 20 is a cross-sectional view illustrating an objective lens according to the second embodiment;

FIG. 21 is a table illustrating lens data on the objective lens according to the second embodiment;

FIG. 22 is a table illustrating a correspondence relationship between a power to be given to a diopter converting element and a distance from the objective lens to a surface of a medium;

FIG. 23 is a graph illustrating spherical aberrations that occur when positive and negative powers are given to the diopter converting element;

FIG. 24 illustrates light beam diagrams of Examples (e1) to (e5) illustrated in FIGS. 22 and 23;

FIG. 25 is a graph illustrating results of adjustments of spherical aberrations according to the second embodiment;

FIG. 26 illustrates light beam diagrams of Examples (f1) to (f5) illustrated in FIG. 25;

FIG. 27 is a table illustrating Strehl ratios of Examples (f1) to (f5) illustrated in FIG. 25;

FIG. 28 is a configuration diagram schematically illustrating a laser machining device according to an embodiment of the presently disclosed subject matter; and

FIG. 29 is a block diagram illustrating a configuration of a control device.

### DETAILED DESCRIPTION OF THE EMBODIMENTS

Embodiments of a spherical aberration adjustment method for an objective optical system, an objective optical system and a laser machining device according to the presently disclosed subject matter are described below with reference to the attached drawings.

### <Objective Optical System>

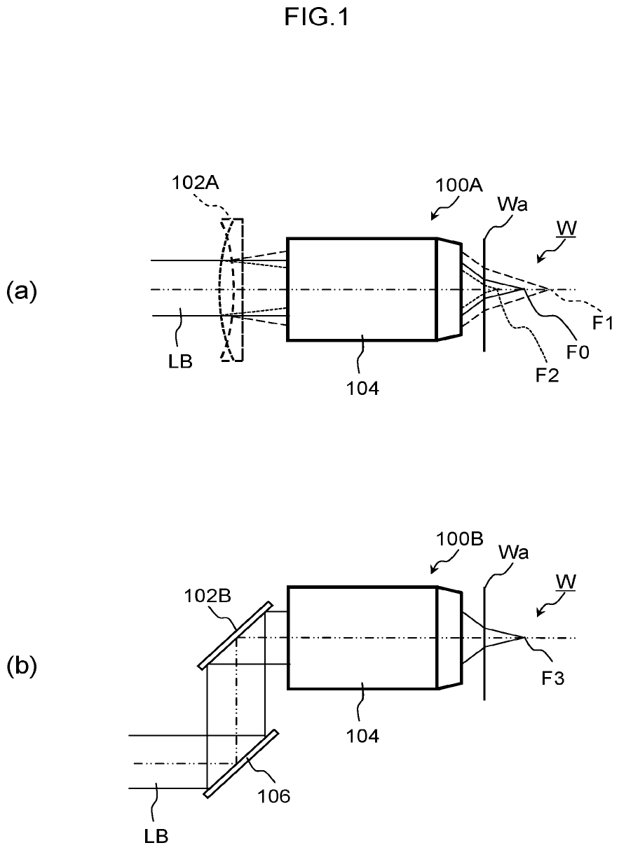

FIG. 1 includes side views illustrating examples of an objective optical system according to an embodiment of the presently disclosed subject matter.

Objective optical systems (100A, 100B) illustrated in FIG. 1 condense laser light LB to a focal point (F0-F3) inside a medium (workpiece of laser machining) W through which the laser light LB passes.

The objective optical system 100A illustrated in portion (a) of FIG. 1 includes a transmission diopter converting element 102A and an objective lens 104. On the other hand, the objective optical system 100B illustrated in portion (b) of FIG. 1 includes a reflection diopter converting element 102B and the objective lens 104. In portion (b) of FIG. 1, reference numeral 106 designates a mirror (such as a total reflection mirror, for example) provided for relaying (bending) an optical path.

In both of the cases, the diopter converting element (102A, 102B) is arranged on an incoming luminous flux side (or the opposite side of the medium W) of the objective lens 104. The diopter converting element (102A, 102B) is given a positive or negative refractive power so that the laser light LB can be converged or diverged to change the convergence or emittance of the laser light LB. Thus, with a diffraction limit kept, the position in the direction of depth of a focal point (F0-F3) inside the medium W can be changed along the direction of optical axis.

Here, the diopter converting element (102A, 102B) is an example of a diopter adjusting optical system, and the positive and negative powers thereof can be varied continuously. When the adjustment function for the powers is inhibited, the diopter converting element (102A, 102B) is optically equivalent to a convex lens or a concave lens.

As the transmission diopter converting element 102A, a focal length variable lens or a transmission spatial light modulator (liquid crystal on silicon: LCOS) can be used, for example. Also, as the reflection diopter converting element 102B, a deformable mirror or a reflection spatial light modulator (LCOS) can be used, for example.

The objective lens 104 condenses laser light LB to a focal point (F0-F3) inside the medium W.

In this embodiment, the depth of the focal point (F0-F3) inside the medium W can be changed by the diopter converting element (102A, 102B). As illustrated in portion (a) of FIG. 1, it is assumed that the focal point when the power of the diopter converting element 102A is set to 0 is F0. The focal point F1 when the power of a concave lens is given to the incident side of the diopter converting element 102A is at a position farther (deeper) from a surface Wa of the medium W than the focal point F0 when the power of the diopter converting element 102A is set to 0. On the other hand, the focal point F2 when the power of a convex lens is given to the incident side of the diopter converting element 102A is at a position closer (shallower) to the surface Wa of the medium W than the focal point F0 when the power of the diopter converting element 102A is set to 0.

As described above, when the depth of the focal point (F0-F3) inside the medium W is changed, a spherical aberration occurs. The objective lens 104 is designed to satisfy a sine condition and thus reduce a spherical aberration and a coma aberration. In a case where such an objective lens 104 is used, when the position of a luminous point of an incoming luminous flux is changed to displace the focal points (F0-F3) toward the direction of optical axis, a spherical aberration occurs.

In this embodiment, the spherical aberration occurring inside the medium W with a change of the depth of the focal point (F0-F3) and the spherical aberration occurring in the objective lens 104 cancel each other out so that movement of the focal point inside the medium W can be achieved while still keeping the condensing performance up to a diffraction limit.

Although no optical element is arranged between the diopter converting element (102A, 102B) and the objective lens 104 in FIG. 1, the presently disclosed subject matter is not limited thereto. An optical system (relay optical system) for relaying laser light LB may be provided between the diopter converting element (102A, 102B) and the objective lens 104. In this case, the diopter converting element (102A, 102B) and the lens pupil of the objective lens 104 are to be optically conjugate.

### (Changing Depth of Focal Point)

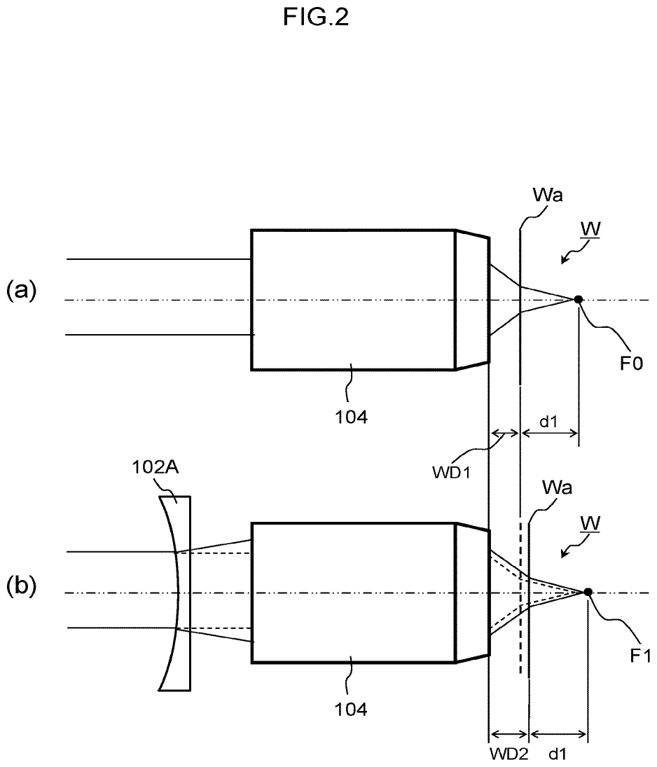

Next, with reference to a case of the objective optical system 100A including the transmission diopter converting element 102A as an example, changing a depth of a focal point is described. FIG. 2 includes side views for explaining an example of changing a depth of a focal point.

As illustrated in portion (a) of FIG. 2, when the power of the diopter converting element 102A is set to 0, a light beam of laser light LB travels straight without being bent by the diopter converting element 102A. Here, the objective lens 104 is designed to condense light in a state that a spherical aberration is corrected to a focal point F0 at a predetermined depth position inside a medium W.

Referring to portion (a) of FIG. 2, it is assumed that a distance WD from the objective lens 104 to a surface Wa of the medium W is WD=WD1, and a distance (depth of a focal point) d from the surface Wa of the medium W to the focal point F0 is d=d1.

As illustrated in portion (b) of FIG. 2, when the power of the concave lens is given to the light incident side of the diopter converting element 102A, the laser light LB is bent by the diopter converting element 102A. In this case, in order to satisfy the relationship that the distance d from the surface Wa of the medium W to the focal point F0 is equal to d1, the distance WD from the objective lens 104 to the surface Wa of the medium W is set to WD2 that is longer than WD1 (WD2>WD1).

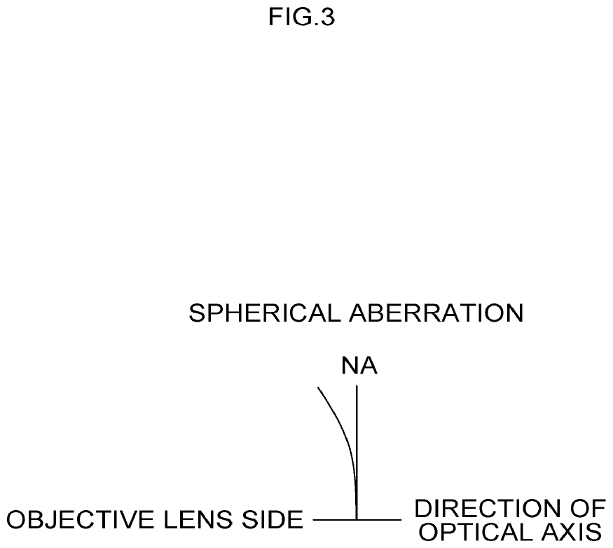

As described above, when the power of the concave lens is given to the light incident side of the diopter converting element 102A, a negative spherical aberration occurs on the objective lens 104 side as illustrated in FIG. 3.

### (Adjustment of Spherical Aberration)

Next, adjustment of a spherical aberration is described.

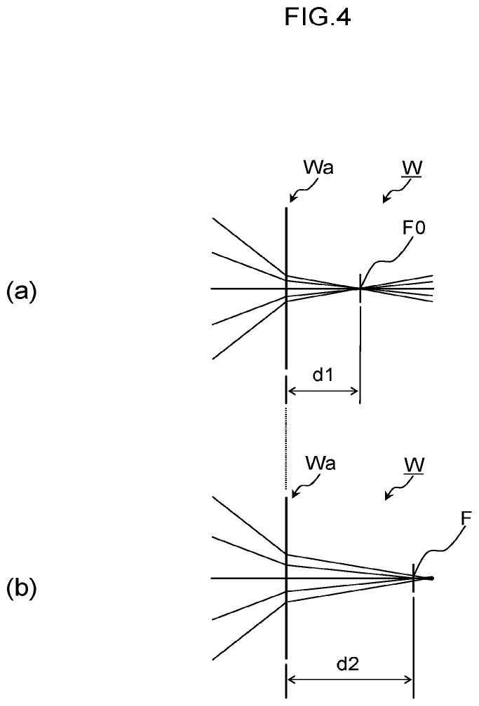

Portion (a) of FIG. 4 is a light beam diagram when the objective lens 104 (see portion (a) of FIG. 2) is used that is designed such that a minimum spherical aberration occurs at a position at the distance d1 from the surface Wa of the medium W to the focal point F0.

As illustrated in portion (b) of FIG. 4, when the objective lens 104 is brought closer to the medium W, a distance d2 from the surface Wa of the medium W to the focal point F is longer than the distance d1.

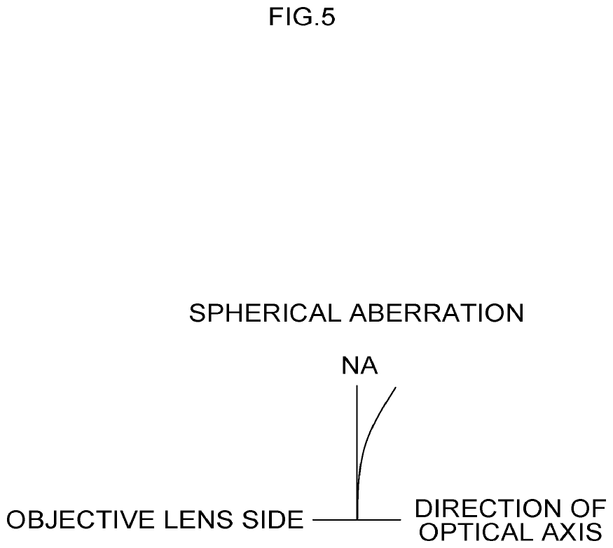

As described above, when the objective lens 104 is brought closer to the medium W, a positive spherical aberration occurs on the objective lens 104 side, as illustrated in FIG. 5.

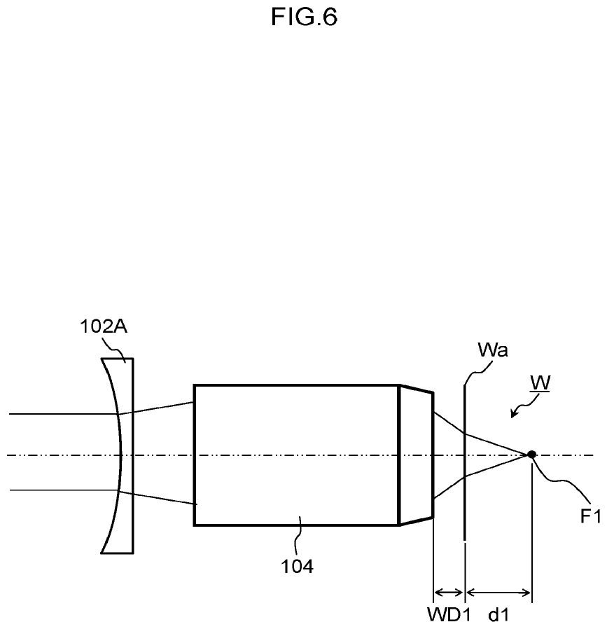

In this embodiment, an adjustment of the spherical aberration of the objective optical system 100A is performed such that the negative spherical aberration illustrated in FIG. 3 and the positive spherical aberration illustrated in FIG. 5 cancel each other out. FIG. 6 is a diagram for explaining an example of an adjustment of a spherical aberration.

In the example illustrated in FIG. 6, the power of the concave lens is given to the light incident side of the diopter converting element 102A. In this case, in order to satisfy the relationship that the distance d from the surface Wa of the medium W to the focal point F0 is equal to the distance d1, the distance WD from the objective lens 104 to the surface Wa of the medium W is required to be longer than WD1 (see portion (b) of FIG. 2), but, in the example illustrated in FIG. 6, the diopter converting element 102A is adjusted such that the distance WD from the objective lens 104 to the surface Wa of the medium W is fixed to WD1, and the depth d of the focal point F0 inside the medium W is d=d1.

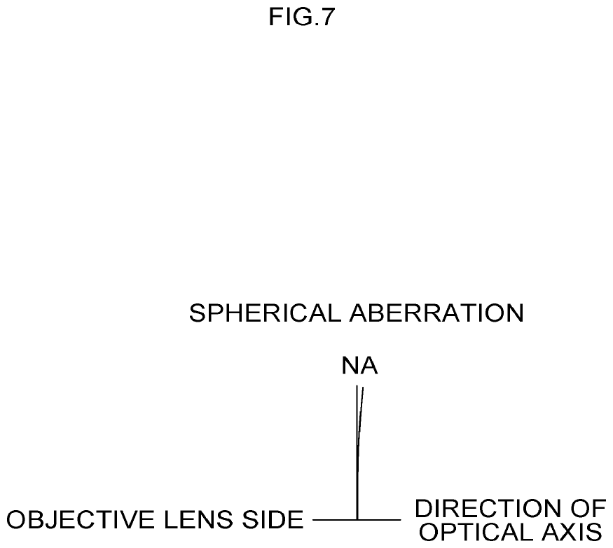

FIG. 7 is a diagram illustrating an adjustment result of an adjustment of a spherical aberration. As illustrated in FIG. 7, it can be seen that the spherical aberration (FIG. 3) due to the depth of the focal point changed by the diopter converting element 102A having the power and the spherical aberration (FIG. 5) due to the objective lens 104 brought closer to the medium W cancel each other out.

As described above, according to this embodiment, the spherical aberration occurring inside the medium W and the spherical aberration occurring in the objective lens 104 are canceled each other so that a movement of the focal point inside the medium W can be achieved while keeping the condensing performance up to a diffraction limit.

Here, when the refractive index of the medium W is greater than or equal to 1.7, the spherical aberration caused by the depth of the focal point inside the medium W and the spherical aberration occurring in the objective lens 104 cancel each other out so that the condensing performance with an aberration, which may be aplanatic, having a Strehl ratio greater than or equal to 0.8 can be achieved (see the first and second embodiments).

Here, the Strehl ratio is a percentage of the ratio of condensing light in an optical system with aberration present when the ratio of condensing light on the image surface of an aplanatic optical system is 100%. In general, a case where the Strehl ratio is 80% is called “diffraction limit”, and in a case where the Strehl ratio is greater than 80%, the objective optical system 100A has adequate condensing performance.

Further, when a medium is a refractive index of 3 or higher, the depth of the focal point can be changed without changing the distance between the objective lens 104 and the medium W. Auto-focusing measures reflection of the surface Wa of the medium W. If the medium has a refractive index of 3 or higher, changing the distance between the objective lens 104 and the medium W is not necessary. Therefore, the depth of a focal point inside the medium W can be changed without changing conditions for the auto-focusing.

Also, as the objective lens 104, an objective lens with a correction circle (see Japanese Patent Application Laid-Open No. 5-119263, for example) that is an objective lens having a spherical aberration adjusting function can also be used. With the objective lens with a correction circle, a spherical aberration can be adjusted by moving at least one group of lenses of a plurality of lenses included in the objective lens 104 along the direction of optical axis to adjust the spacings. Thus, since the depth adjustment can be performed in which a spherical aberration is corrected inside the medium W, the range of the depth can then be extended from a part near the surface to a deeper part.

Here, it is preferable that the following conditional expression (1) is satisfied.

$$\begin{matrix}[ Expression 1 ] & \\ 0.1 < \frac{f \cdot NA}{n} < 1.4 & ( 1 )\end{matrix}$$

where f is a focal length of the objective lens 104, NA is a numerical aperture, and n is a refractive index (absolute refractive index) of the medium W. If the f·NA/n value is lower than 0.1, a sufficient NA may not be acquired while, if the f·NA/n value is higher than 1.4, designing the objective lens 104 is difficult.

Further, it is preferable that the following conditional expression (2) is satisfied.

$$\begin{matrix}[ Expression 2 ] & \\ 0.3 < \frac{f \cdot NA}{n} < 0.8 & ( 2 )\end{matrix}$$

By satisfying the aforementioned conditional expression, the objective lens 104 can be designed by which the distance between the objective lens 104 and the medium W can be proper.

Also, it is preferable that the numerical aperture (NA) of the objective lens 104 is greater than or equal to 0.6 and less than 0.9. The range of the values of the numerical aperture is based on the following reasons. That is, if the numerical aperture of the objective lens 104 is less than 0.6, laser light LB cannot be converged, and the energy density cannot be increased enough, which makes acquisition of an amount of energy required for machining inside the medium W difficult. On the other hand, if the numerical aperture of the objective lens 104 is greater than or equal to 0.9, the distance WD to the surface Wa of the medium W cannot be long due to difficulty in optical design of the objective lens 104. For, example, an index of the required distance WD is about 1 mm or longer.

### First Embodiment

In a first embodiment, it is assumed that the wavelength of laser light LB is 1,064 nm, the numerical aperture (NA) of the objective lens 104 is 0.65, and the refractive index of the medium W is 3.55. Then, an objective lens 104 is used which is designed such that a minimum spherical aberration can be acquired if the depth d of a focal point inside the medium W is d=0.5 mm.

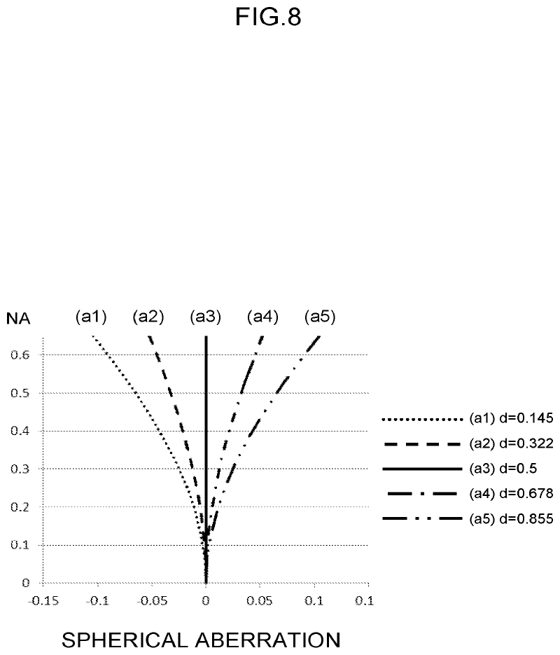

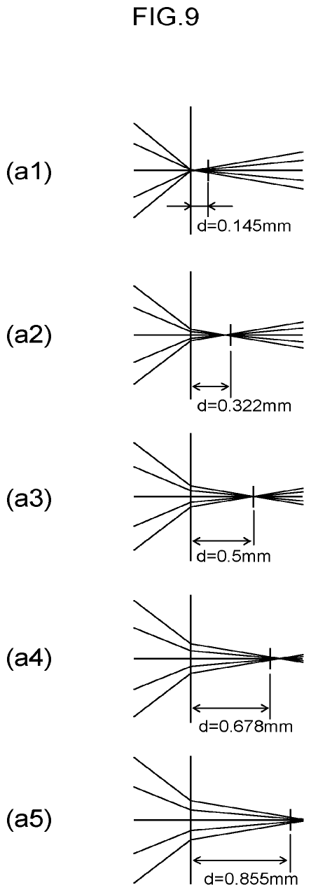

FIG. 8 is a graph illustrating results of calculations of a spherical aberration when the depth d of a focal point is changed in the first embodiment. FIG. 9 illustrates light beam diagrams of Examples (a1) to (a5) illustrated in FIG. 8.

As illustrated in FIG. 8, when the depth d of a focal point is shorter than 0.5 mm (Example (a3)), a negative spherical aberration occurs as in Example (a1) and Example (a2). Conversely, when the depth d of a focal point is larger than 0.5 mm, a positive spherical aberration occurs as in Example (a4) and Example (a5).

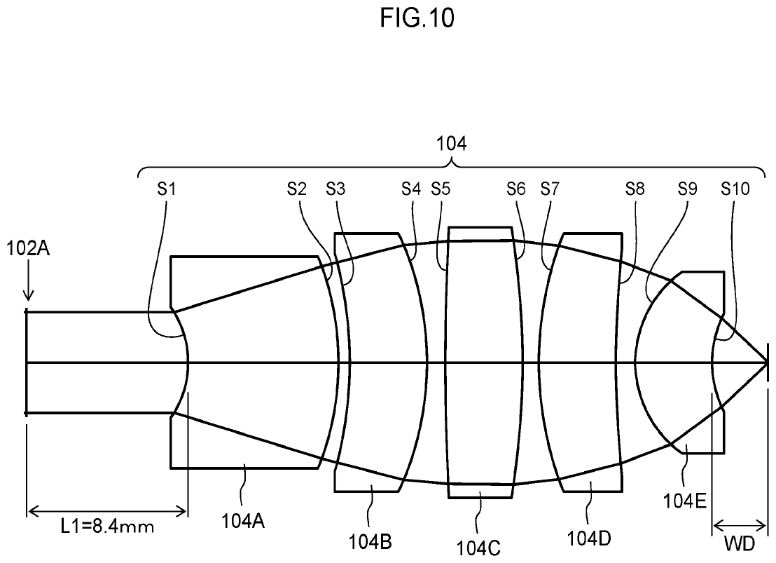

FIG. 10 is a cross-sectional view illustrating the objective lens according to the first embodiment. The objective lens 104 according to the first embodiment provides an NA of 0.65, and a focal length of 3.6 mm when the wavelength of laser light LB is 1,064 nm.

As illustrated in FIG. 10, the objective lens 104 includes five lenses 104A to 104E. The objective lens 104 includes lenses 104A to 104E in order from the incident side (upstream side) of laser light LB.

Also, the diopter converting element 102A is arranged at a position where a distance L1 from the surface on the most upstream side (surface S1 of the lens 104A) of the objective lens 104 is L1=8.4 mm.

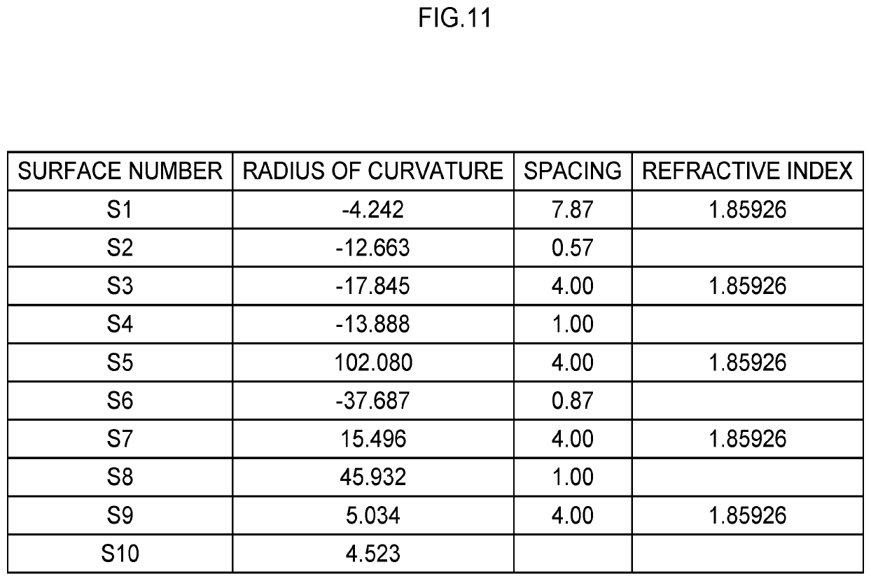

Lens data on the objective lens 104 according to the first embodiment is illustrated in FIG. 11. On the table of FIG. 11, radii of curvature of the surfaces S1 to S10 of the five lenses 104A to 104E, intervals (spacings) to the next surface on the downstream side, and refractive indices of the lenses 104A to 104E are illustrated.

The objective lens 104 according to the first embodiment is designed such that, when laser light LB of parallel light beams are entered, a minimum spherical aberration is caused at a position at a distance of 0.5 mm from the surface Wa of the medium W with a refractive index of 3.55.

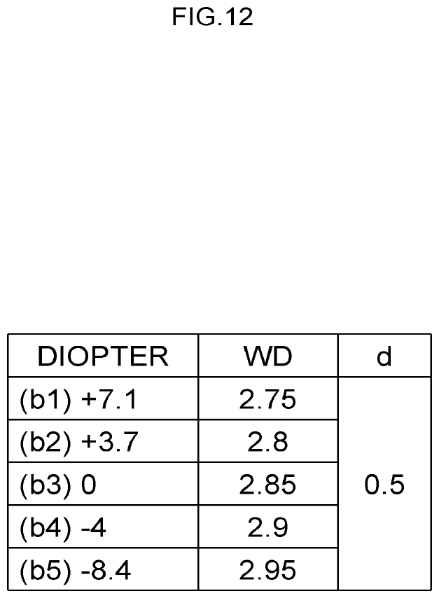

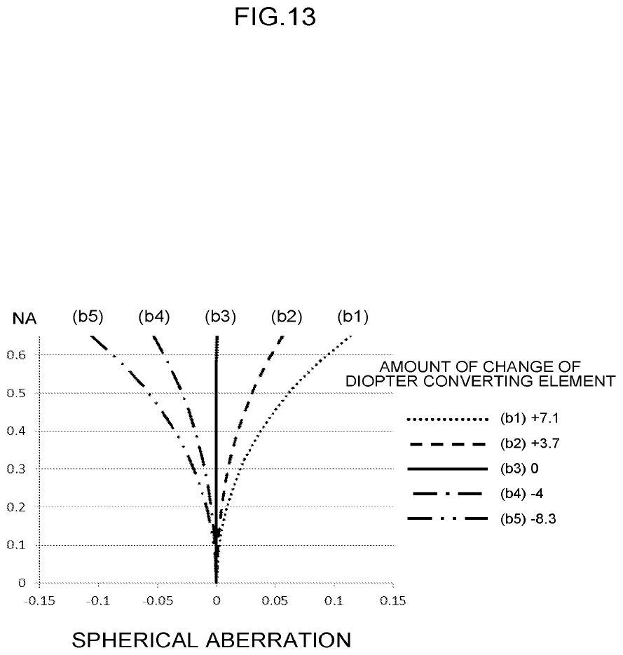

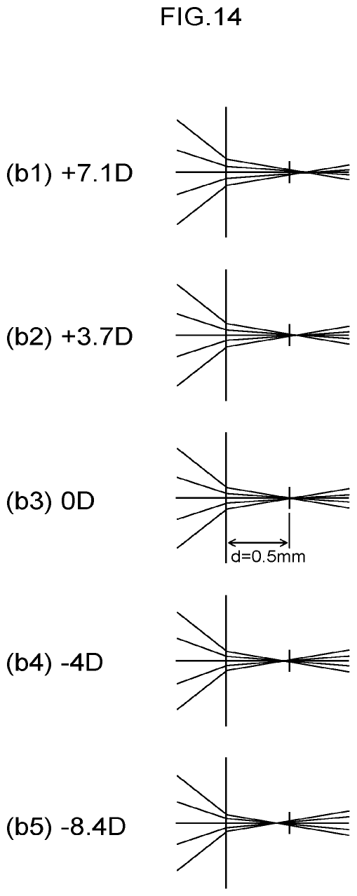

FIG. 12 is a table illustrating changes in distance WD from the objective lens 104 to the surface Wa of the medium W for achieving a depth d of a focal point of d=0.5 mm when positive and negative powers are given to the diopter converting element 102A. FIG. 13 is a graph illustrating spherical aberrations that occur when positive and negative powers are given to the diopter converting element 102A, and FIG. 14 illustrates light beam diagrams of Examples (b1) to (b5) illustrated in FIGS. 12 and 13.

In Example (b1), a positive power of +7.1 D is given to the diopter converting element 102A. Converting a positive power of +7.1 D to a focal length, the following is acquired.

$$\frac{1000}{7.1} ⇋ 141 mm \qquad [ Expression 3 ]$$

In other words, in Example (b1), the diopter converting element 102A functions as a positive lens with a focal length of about 141 mm. In this case, as illustrated in FIG. 13 (Example (b1)), a spherical aberration occurs on the positive side. Then, as illustrated in FIG. 12, the distance WD from the objective lens 104 to the surface Wa of the medium W for achieving a depth d of a focal point of d=0.5 mm is equal to 2.75 mm that is shorter than that in Example (b3) (WD=2.85 mm) where no power is given to the diopter converting element 102A.

In Example (b3), the power of the diopter converting element 102A is zero, and converting the power zero to a focal length results in an infinite focal length. In this case, it is equivalent to input of parallel light beams to the objective lens 104. Then, as illustrated in FIG. 13 (Example (b3)), a minimum spherical aberration occurs. Also, as described above, in the case of Example (b3), WD=2.85 (see FIG. 12).

In Example (b5), a negative power of −8.4 D is given to the diopter converting element 102A. Converting a negative power of −8.4 D to a focal length, the following is acquired.

$$\frac{1000}{- 8.4} ⇋ - 119 mm \qquad [ Expression 4 ]$$

In other words, in Example (b5), the diopter converting element 102A functions as a negative lens with a focal length of about 119 mm. In this case, as illustrated in FIG. 13 (Example (b5)), a spherical aberration occurs on the negative side. Then, as illustrated in FIG. 12, the distance WD is equal to 2.95 mm that is longer than that in Example (b3) (WD=2.85 mm).

As described above, in the examples illustrated in FIG. 12, as the power to be given to the diopter converting element 102A increases, the distance WD decreases.

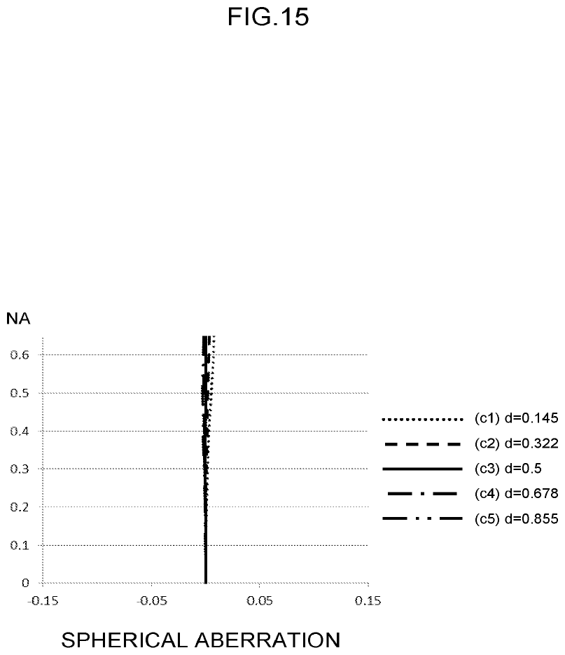

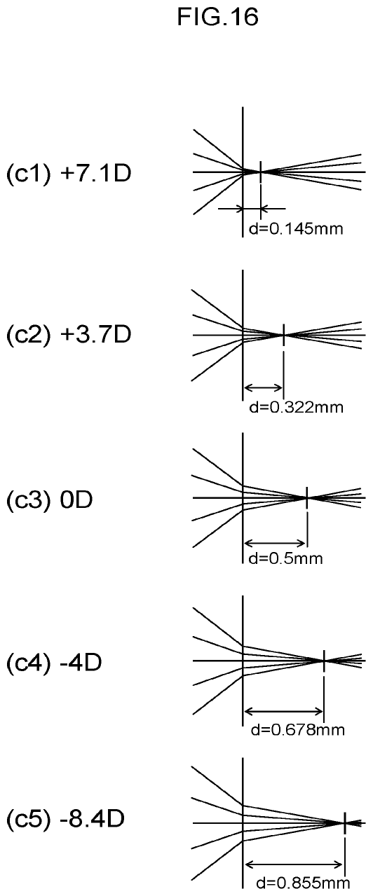

FIG. 15 is a graph illustrating results of adjustments of spherical aberrations according to the first embodiment, and FIG. 16 illustrates light beam diagrams of Examples (c1) to (c5) illustrated in FIG. 15.

In the examples illustrated in FIG. 15, as the depth of the focal point decreases (as the distance from the surface of the medium W decreases) compared with Example (c3) where the diopter converting element 102A has power zero, the positive power to be given to the diopter converting element 102A increases. On the other hand, as the depth of the focal point increases (as the distance from the surface of the medium W increases) compared with the case of Example (c3), the absolute value of the negative power to be given to the diopter converting element 102A increases. Thus, as illustrated in FIG. 15, the spherical aberration occurring inside the medium W illustrated in FIG. 8 and the spherical aberration occurring in the objective lens 104 illustrated in FIG. 13 cancel each other out.

While the distance WD is changed in the examples in FIG. 13, a position d of a focal point inside the medium W is calculated by fixing the distance WD to WD=2.85 mm with the diopter converting element 102A having power zero in FIG. 15.

As illustrated in FIG. 16, d=0.145 mm with WD=2.85 mm in Example (c1), and d=0.5 mm with WD=2.85 mm when the diopter converting element 102A has power zero in Example (c3). Then, in Example (c5), d=0.855 mm with WD=2.85 mm.

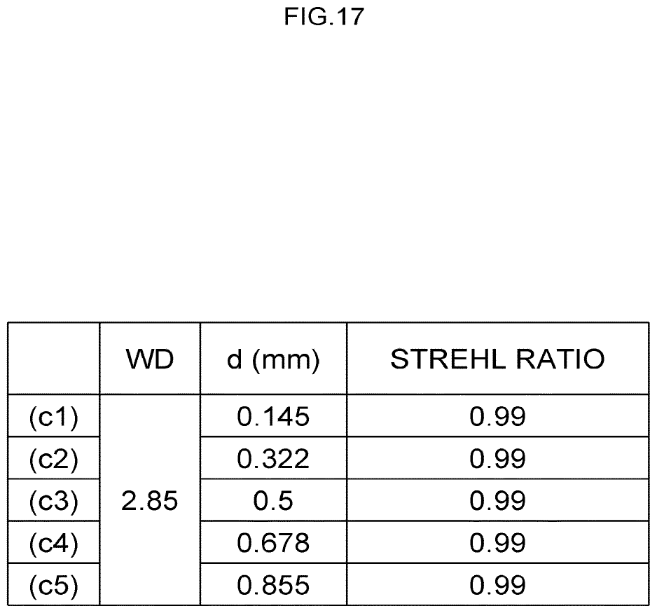

FIG. 17 is a table illustrating Strehl ratios of Examples (c1) to (c5). In the first embodiment, in all of Examples (c1) to (c5), the spherical aberrations cancel each other out, which result in smaller spherical aberrations, and the Strehl ratio is 0.99. In other words, in all of the examples of Examples (c1) to (c5), it can be seen that the objective optical system 100A has an adequate condensing performance that is sufficiently higher than 0.8 which is a diffraction limit.

### Second Embodiment

In a second embodiment, it is assumed that the wavelength of laser light LB is 1,064 nm, the NA of an objective lens 104 is 0.83, and the refractive index of the medium W is 3.55. Then, an objective lens is used which is designed such that a minimum spherical aberration can be acquired if the depth d of a focal point inside the medium W is d=0.5 mm.

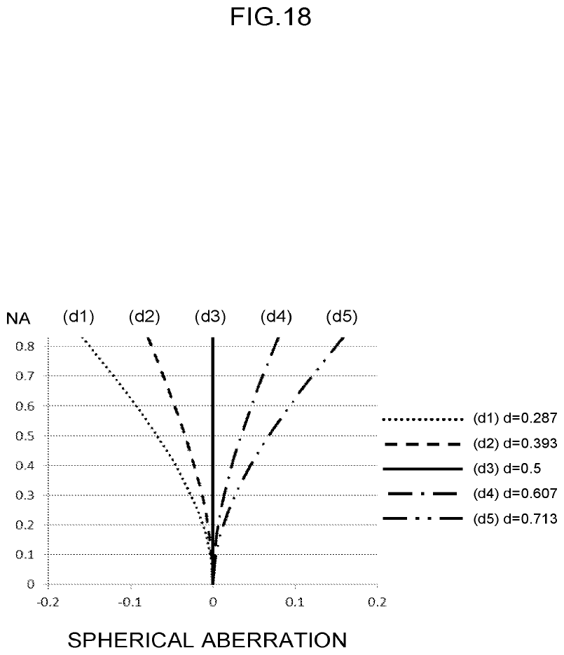

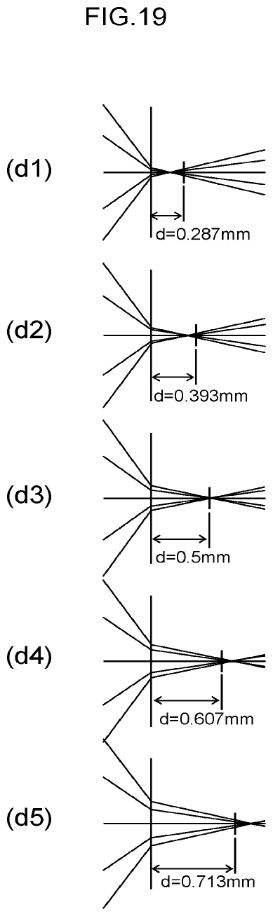

FIG. 18 is a graph illustrating results of calculations of a spherical aberration when the depth d of a focal point is changed in the second embodiment. FIG. 19 illustrates light beam diagrams of Examples (d1) to (d5) illustrated in FIG. 18.

As illustrated in FIG. 18, when the depth d of a focal point is smaller than 0.5 mm (Example (d3)), a negative spherical aberration occurs as in Examples (d1) and (d2).

Conversely, when the depth d of a focal point is larger than 0.5 mm, a positive spherical aberration occurs as in Examples (d4) and (d5).

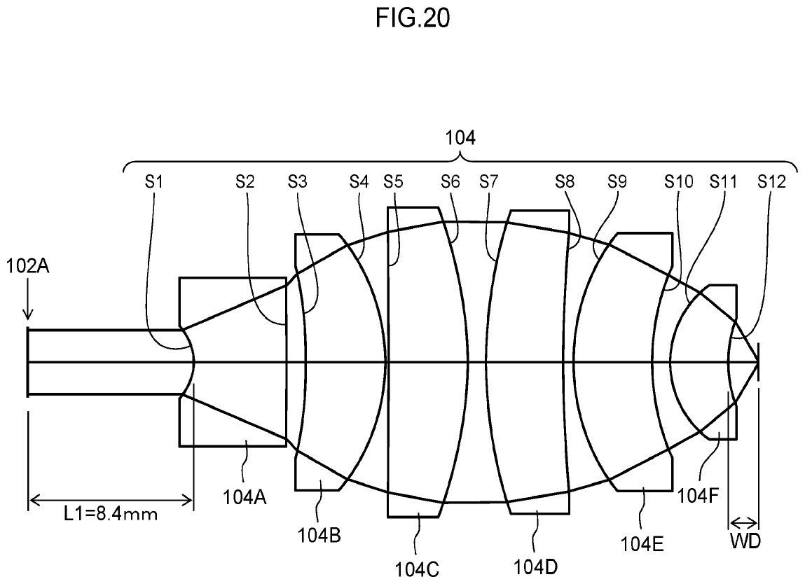

FIG. 20 is a cross-sectional view illustrating an objective lens according to the second embodiment. The objective lens 104 according to the second embodiment provides an NA of 0.83, and a focal length of 1.8 mm when the wavelength of laser light LB is 1,064 nm.

As illustrated in FIG. 20, the objective lens 104 includes six lenses 104A to 104F. The objective lens 104 includes lenses 104A to 104F in order from the incident side (upstream side) of laser light LB.

Also, the diopter converting element 102A is arranged at a position where a distance L1 from the surface on the most upstream side (surface S1 of the lens 104A) of the objective lens 104 is L1=8.4 mm.

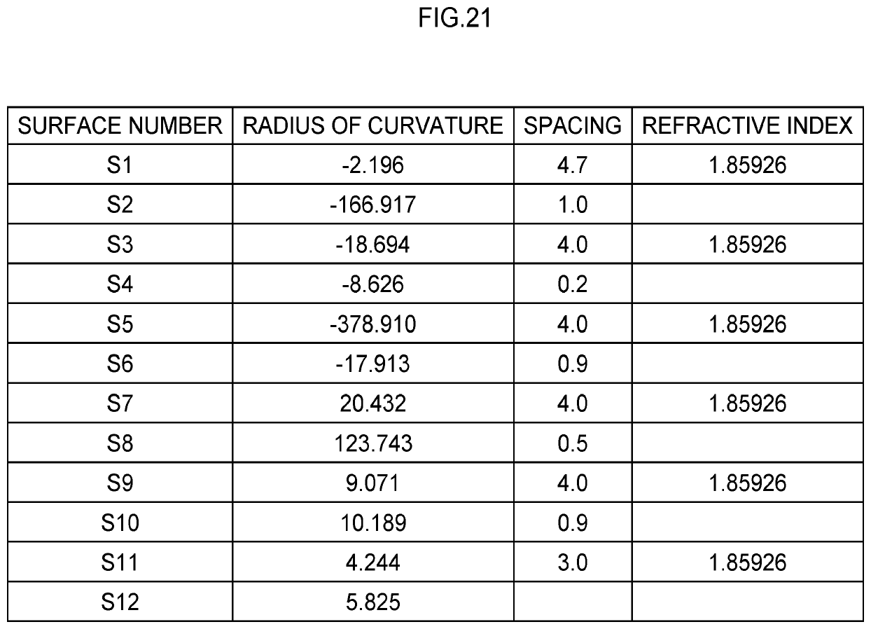

Lens data on the objective lens 104 according to the second embodiment is illustrated in FIG. 21. On the table illustrated in FIG. 21, radii of curvature of the surfaces S1 to S12 of the six lenses 104A to 104F, intervals (spacings) to the next surface on the downstream side, and refractive indices of the lenses 104A to 104F are illustrated.

The objective lens 104 according to the second embodiment is designed such that, when laser light LB of parallel light beams are entered, a minimum spherical aberration is caused at a position at a distance of 0.5 mm from the surface Wa of the medium W with a refractive index of 3.55.

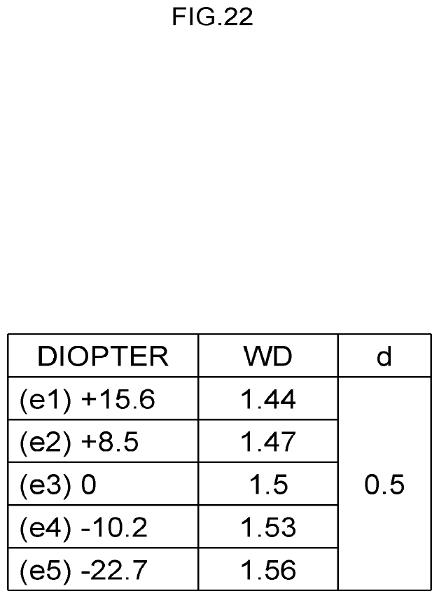

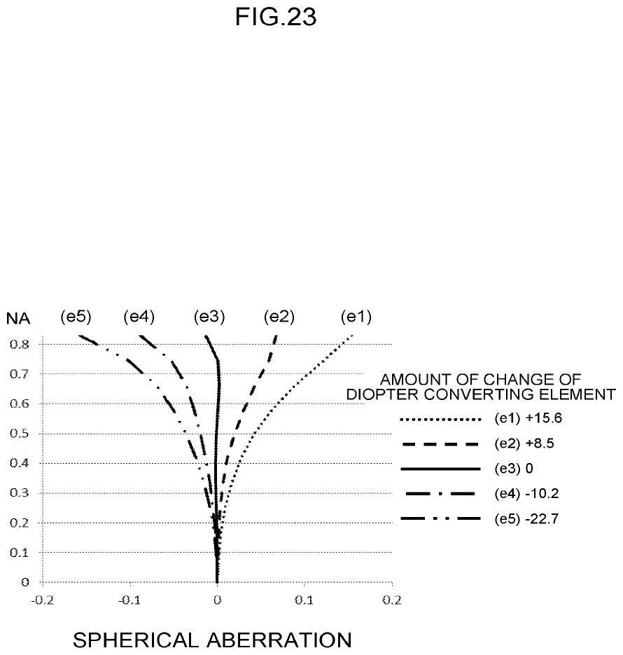

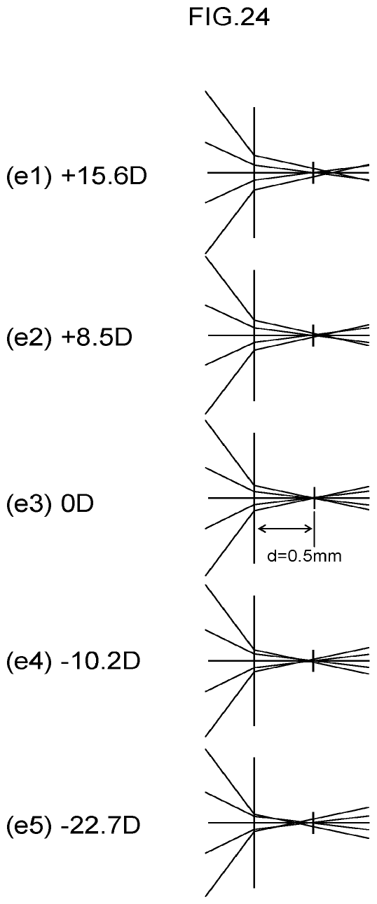

FIG. 22 is a table illustrating changes in distance WD from the objective lens 104 to the surface Wa of the medium W for achieving a depth d of a focal point of d=0.5 mm when positive and negative powers are given to the diopter converting element 102A. FIG. 23 is a graph illustrating spherical aberrations that occur when positive and negative powers are given to the diopter converting element 102A, and FIG. 24 illustrates light beam diagrams of Examples (e1) to (e5) illustrated in FIGS. 22 and 23.

In Example (e1), a positive power of +15.6 D is given to the diopter converting element 102A. Converting a positive power of +15.6 D to a focal length, the following is acquired.

$$\frac{1000}{15.6} ⇋ 64 mm \qquad [ Expression 5 ]$$

In other words, in Example (e1), the diopter converting element 102A is a positive lens with a focal length of about 64 mm. In this case, as illustrated in FIG. 23 (Example (e1)), a spherical aberration occurs on the positive side. Then, as illustrated in FIG. 22, the distance WD from the objective lens 104 to the surface Wa of the medium W for achieving a depth d of a focal point of d=0.5 mm is equal to 1.44 mm that is shorter than that in Example (e3) (WD=1.5 mm) where no power is given to the diopter converting element 102A.

In Example (e3), the power of the diopter converting element 102A is zero, and converting the power zero to a focal length results in an infinite focal length. In this case, it is equivalent to input of parallel light beams to the objective lens 104. Then, as illustrated in FIG. 23 (Example (e3)), a minimum spherical aberration occurs. Also, as described above, in the case of Example (e3), WD=1.5 (see FIG. 22).

In Example (e5), a negative power of −22.7 D is given to the diopter converting element 102A. Converting a negative power of −22.7 D to a focal length, the following is acquired.

$$\frac{1000}{- 22.7} ⇋ - 44 mm \qquad [ Expression 6 ]$$

In other words, in Example (e5), the diopter converting element 102A is a negative lens with a focal length of about 44 mm. In this case, as illustrated in FIG. 23 (Example (e5)), a spherical aberration occurs on the negative side. Then, as illustrated in FIG. 22, the distance WD is equal to 1.56 mm that is longer than that in Example (e3) (WD=1.5 mm).

As described above, in the example illustrated in FIG. 22, as the power to be given to the diopter converting element 102A increases, the distance WD decreases.

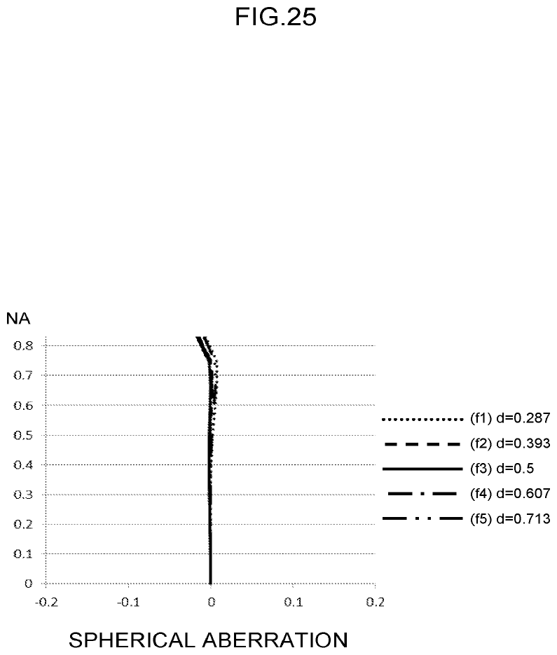

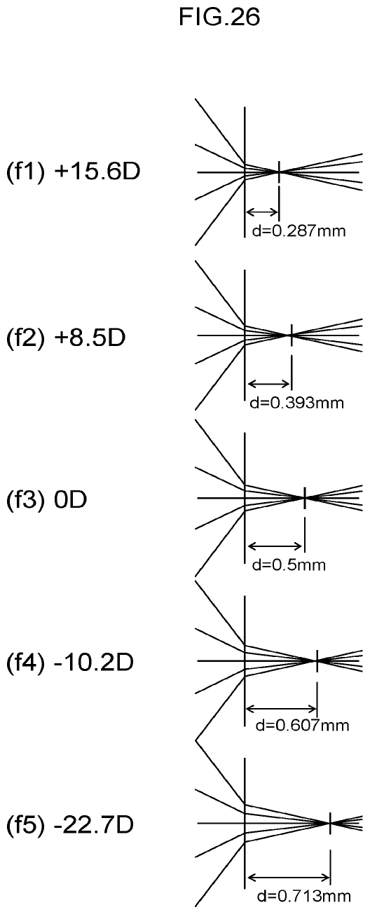

FIG. 25 is a graph illustrating results of adjustments of spherical aberrations according to the second embodiment, and FIG. 26 illustrates light beam diagrams of Examples (f1) to (f5) illustrated in FIG. 25.

In the example illustrated in FIG. 25, as the depth of the focal point decreases (as the distance from the surface of the medium W decreases) compared with Example (f3) where the power of the diopter converting element 102A is zero, the positive power to be given to the diopter converting element 102A increases. On the other hand, as the depth of the focal point increases (as the distance from the surface of the medium W increases) compared with Example (f3), the negative power to be given to the diopter converting element 102A increases. Thus, as illustrated in FIG. 25, the spherical aberration occurring inside the transparent medium illustrated in FIG. 18 and the spherical aberration occurring in the objective lens 104 illustrated in FIG. 23 cancel each other out.

While the distance WD is changed in the examples in FIG. 23, a position d of a focal point inside the medium W is calculated by fixing the distance WD to WD=1.5 mm with the diopter converting element 102A having power zero in FIG. 25.

As illustrated in FIG. 26, d=0.287 mm with WD=1.5 mm in Example (f1), and d=0.5 mm with WD=1.5 mm where the power of the diopter converting element 102A is zero in Example (f3). Then, in Example (f5), d=0.713 mm with WD=1.5 mm.

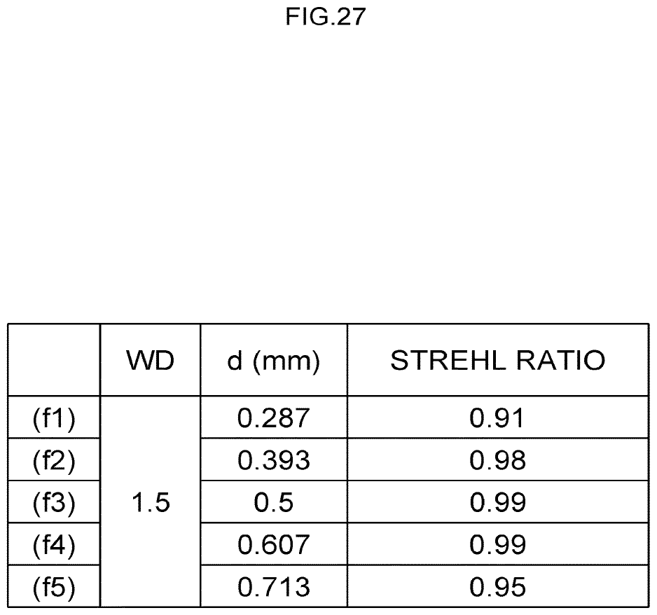

FIG. 27 is a table illustrating Strehl ratios of Examples (f1) to (f5). In the second embodiment, in all of the examples of Examples (f1) to (f5), the spherical aberrations cancel each other out, which result in smaller spherical aberrations, and all of the Strehl ratios are greater than or equal to 0.9. In other words, in all of the examples of Examples (f1) to (f5), it can be seen that the objective optical system 100A has an adequate condensing performance that is sufficiently higher than 0.8 which is a diffraction limit.

According to the aforementioned embodiments, no mechanism (such as a mechanical moving mechanism, for example) that moves an emission position of a light source of laser light LB is needed.

According to the method that changes a depth d of a focal point by moving an emission position of a light source, the amount of movement of the focal point follows the image formation formula relating to a single lens as is described below.

$$\frac{1}{a} + \frac{1}{b} = \frac{1}{f} \qquad [ Expression 7 ]$$

Here, it is assumed that the objective lens is an ideal thin lens having a thickness of 0, and the objective lens has a focal length f, the distance from a light source to the objective lens is a, and the distance from the objective lens to the focal point is b.

For example, an arrangement in which a has a higher value than b is adopted in Japanese Patent Application Laid-Open No. 5-119263. Thus, the amount of change of a is increased when the amount of b changes. For example, when f=4 mm, b=4.08 mm, assuming a=200 mm at an initial state. If a=150 mm by moving the light source by 50 mm from the initial state, b=4.11 mm. In this case, a difference of 0.03 mm of b corresponds to the amount of movement of the focal point.

As described above, according to the method that moves the emission position of a light source, the amount of movement of the focal point is smaller with respect to the amount of movement of the light source. In other words, as the distance of a movement of the focal point increases, the amount of movement of the light source increases, which may possibly increase the size of the mechanism for moving the light source. According to the aforementioned embodiments, since no mechanism for moving the emission position of the light source of laser light LB in order to change the depth d of the focal point is necessary, the device can be simplified.

### <Laser Machining Device>

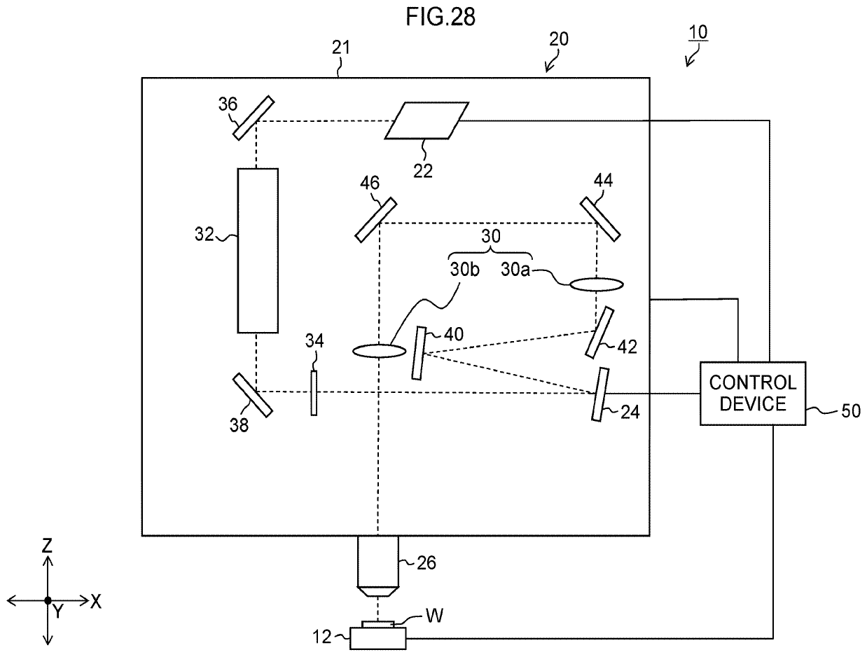

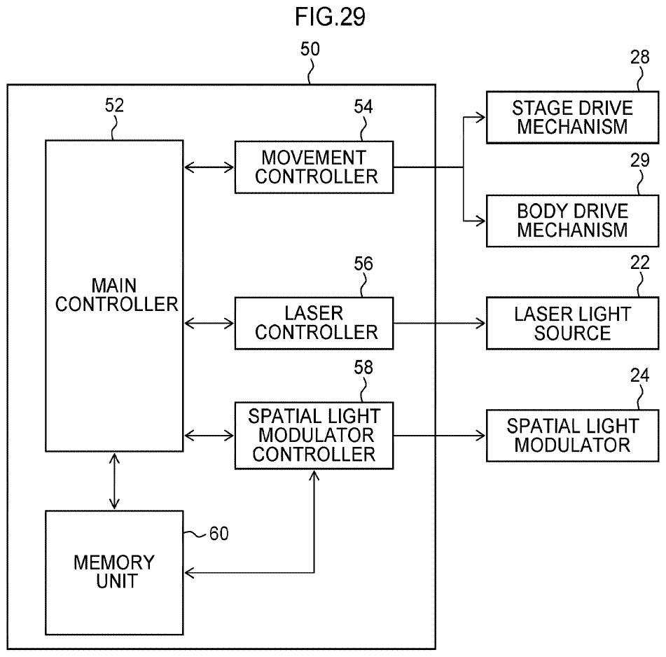

Next, an example of a laser machining device including the objective optical system (100A, 100B) according to the aforementioned embodiments is described with reference to FIGS. 28 and 29.

### (Configuration of Laser Machining Device)

FIG. 28 is a configuration diagram schematically illustrating a laser machining device according to an embodiment of the presently disclosed subject matter. As illustrated in FIG. 28, a laser machining device 10 of this embodiment includes a stage 12, a machining device body (optical system unit) 20, a machining lens 26, and a control device 50. Although there is illustrated a case where the machining device body 20 and the control device 50 are configured separately according to this embodiment, the scope of the presently disclosed subject matter is not limited to the case. For example, the machining device body 20 may include a part or all of the control device 50.

The stage 12 sucks and holds a workpiece. The stage 12 is configured to be movable in an X direction and a 0 direction by a stage drive mechanism 28 (see FIG. 29). The stage drive mechanism 28 may be configured by any of a variety of mechanism such as a ball screw mechanism, a linear motor mechanism, or the like, for example. Operations of the stage drive mechanism 28 are controlled by the control device 50 (a movement control unit 54). In FIG. 28, three of X, Y and Z directions are orthogonal to each other, and, among them, the X direction and the Y direction are horizontal directions, and the Z direction is a vertical direction. Also, the 0 direction is a direction of rotation about a vertical direction axis (Z axis) as a rotation axis.

According to this embodiment, a semiconductor wafer (“wafer” hereinafter) W such as a silicon wafer is applied as a workpiece. The wafer W is divided into a plurality of regions by planned cutting lines arranged in a grid pattern, and any of various devices included in a semiconductor chip is formed in each of the divided regions. Although a case is described where the wafer W is applied as a workpiece according to this embodiment, the presently disclosed subject matter is not limited thereto, but, for example, a glass substrate, a piezoelectric ceramic substrate, or the like is also applicable.

The wafer W has a front surface (device surface) having a back griding tape (hereinafter, BG tape) having a tackiness agent pasted thereto and having a device thereon and is mounted on the stage 12 with its back surface facing upward. The thickness of the wafer W is not particularly limited but is typically greater than or equal to 700 μm or more and typically falls within a range of 700 μm to 800 μm.

The wafer W may have one surface with a dicing tape having a tackiness agent pasted thereto, and the wafer W integrated into a frame through the dicing tape may be mounted to the stage 12.

The machining device body 20 includes a cabinet 21, a laser light source 22, a spatial light modulator 24, a relay optical system 30, a beam expander 32, and a λ/2 wave plate 34.

Inside of the cabinet 21, the laser light source 22, the spatial light modulator 24, the relay optical system 30, the beam expander 32, and the λ/2 wave plate 34 are arranged. The laser light source 22 may be arranged outside of the cabinet 21 (for example, on the ceiling or a side surface of the cabinet 21 or the like). Also, the machining lens 26 is removably attached to a bottom surface of the cabinet 21.

The machining device body 20 is configured to be movable in the Y direction and the Z direction by a body drive mechanism 29 (see FIG. 29). The body drive mechanism 29 can be configured by any of various mechanisms such as a ball screw mechanism, a linear motor mechanism or the like, for example. Operations of the body drive mechanism 29 are controlled by the control device 50 (by the movement control unit 54). Thus, in accordance with a machining position (a position where a laser machining region is to be formed) on the wafer W, the machining device body 20 can be moved in the Y direction, and the machining device body 20 can be moved in the Z direction. Therefore, by changing the position of the focal point of the laser light LB condensed by the machining lens 26, the laser machining region can be formed at a desired position on the wafer W.

The laser light source (IR laser light source) 22 emits laser light L for machining for forming a laser machined region inside the wafer W. The operation of emitting laser light L by the laser light source 22 is controlled by the control device 50 (laser control unit 56). As conditions for the laser light L, the light source is a semiconductor laser driven Nd:YAG (Yttrium Aluminum Garnet) laser, the wavelength is 1.1 m, the laser light spot cross section is 3.14×10⁻⁸ cm², the oscillation form is Q switch pulses, the cyclic frequency is 80 to 200 kHz, the pulse width is 180 to 370 ns, and the output is 8 W, for example.

The spatial light modulator 24 is a phase modulation type spatial light modulator that includes a light modulating surface having a plurality of two-dimensionally arranged pixels (micromodulation elements) thereon and, for each of the pixels, modulates a phase of light entering the light modulating surface. The spatial light modulator 24 is arranged at a position that is optically conjugate with a lens pupil (exit pupil) 26a of the machining lens 26. The spatial light modulator 24 modulates a phase of light entering the light modulating surface for each pixel based on a predetermined modulation pattern defined by a spatial light modulator control unit 58, which will be described below, and emits the modulated light toward a predetermined direction. As the spatial light modulator 24, a reflective liquid crystal (liquid crystal on silicon: LCOS) spatial light modulator (SLM) is used, for example. Operations of the spatial light modulator 24 and the modulation pattern presented by the spatial light modulator 24 are controlled by the control device 50 (spatial light modulator control unit 58). The modulation pattern may be a pattern (two-dimensional information) in which control values (phase change amounts) each corresponding to each of the plurality of pixels included in the light modulating surface of the spatial light modulator 24 are two-dimensionally distributed or may be anything like coefficient information when a modulation within a modulation region (light modulating surface) is expressed by a certain function.

The machining lens 26 is an objective lens (condensing optical system) that condenses laser light L to inside of the wafer W. This machining lens 26 has a numerical aperture (NA) equal to 0.65, for example.

The relay optical system 30 is provided on an optical path for laser light L between the spatial light modulator 24 and the machining lens 26. The relay optical system 30 includes at least two lenses 30a and 30b (hereinafter, “first lens 30a”, “second lens 30b”). The relay optical system 30 constitutes an afocal optical system (both-side telecentric optical system) and projects the laser light L modulated by the spatial light modulator 24 to the machining lens 26. This relay optical system 30 is a both-side telecentric optical reduction system, and the projection magnification (hereinafter, also simply called “magnification”) is lower than 1 (for example, 0.66).

The beam expander 32 expands the laser light L emitted from the laser light source 22 so as to have a proper beam diameter for the spatial light modulator 24. The λ/2 wave plate 34 adjusts a laser light incident plane of polarization to the spatial light modulator 24.

The machining device body 20 further includes an alignment optical system for performing alignment with the wafer W and an auto-focusing unit for keeping a constant distance (working distance) between the wafer W and the machining lens 26, and the like, though not illustrated in the figure.

The control device 50 is implemented by a general-purpose computer such as a personal computer, a microcomputer or the like, for example.

The control device 50 includes a central processing unit (CPU), a read only memory (ROM), a random access memory (RAM), an input/output interface, and the like. In the control device 50, various programs such as a stored control program are decompressed in the RAM, and the programs decompressed in the RAM are executed by the CPU so that functions of the components within the control device 50 illustrated in FIG. 29 are implemented, and various kinds of arithmetic operation processing and control processing are executed through the input/output interface.

FIG. 29 is a block diagram illustrating a configuration of the control device 50. As illustrated in FIG. 29, the control device 50 functions as a main control unit 52, a movement control unit 54, a laser control unit 56, a spatial light modulator control unit 58, and a memory unit 60.

The main control unit 52 centrally controls each of the components included in the control device 50 (including the movement control unit 54, the laser control unit 56, the spatial light modulator control unit 58, and the memory unit 60).

The movement control unit 54 controls relative movements of the stage 12 and the machining device body 20. The movement control unit 54 outputs a control signal that controls movements of the stage 12 in the X direction and in the θ direction to the stage drive mechanism 28 and outputs a control signal that controls movements of the machining device body 20 in the Y direction and the Z direction to the body drive mechanism 29.

The laser control unit 56 controls emission of laser light L. The laser control unit 56 outputs control signals that controls a wavelength, pulse width, intensity, emission timing, cyclic frequency and the like of laser light L to the laser light source 22.

The spatial light modulator control unit 58 outputs a control signal that controls operations of the spatial light modulator 24 to the spatial light modulator 24. In other words, the spatial light modulator control unit 58 performs control that causes the spatial light modulator 24 to present a predetermined modulation pattern.

The memory unit 60 includes an external memory (such as a hard disk, a flexible disk, or the like, for example) included in the control device 50 or an internal memory (such as a RAM, a ROM or the like including a semiconductor memory, for example).

As the machining lens 26 of the laser machining device 10 as described above, the objective optical system (100A, 100B) according to the embodiments can be used. Thus, in forming laser machining regions at different depth positions inside the wafer W that is a medium W, condensing performance can be secured irrespective of the depth of a focal point, and the precision of the machining on the laser machining regions can be secured.

Although, according to the aforementioned embodiments, the example in which the objective optical system (100A, 100B) is applied as the laser machining device 10 is described, the presently disclosed subject matter is not limited thereto. The objective optical systems (100A, 100B) according to the aforementioned embodiments are also applicable to a microscope objective lens. In this case, a resolution can be secured irrespective of the depth of the focused focal point inside a specimen.

### REFERENCE SIGNS LIST

100A, 100B: objective optical system, 102A, 102B: diopter converting element, 104: objective lens, 106: mirror

What is claimed is:

1. A spherical aberration adjustment method for an objective optical system having an objective lens, and a diopter adjusting optical system that is arranged on an opposite side of a medium with respect to the objective lens and includes a lens,
the method including
changing an emittance or convergence of a luminous flux of laser light by the diopter adjusting optical system, and changing a depth of a focal point inside the medium with a diffraction limit of the objective optical system kept.

2. The spherical aberration adjustment method for the objective optical system according to claim 1, wherein
the changing the emittance or the convergence includes increasing a positive power to be given to the diopter adjusting optical system as a distance from a surface of the medium to the focal point inside the medium decreases, and increasing an absolute value of a negative power to be given to the diopter adjusting optical system as the distance from the surface of the medium to the focal point inside the medium increases.

3. The spherical aberration adjustment method for the objective optical system according to claim 1, wherein the medium has a refractive index of 1.7 or higher.

4. An objective optical system comprising:
an objective lens; and
a diopter adjusting optical system that is arranged on an opposite side of a medium with respect to the objective lens and includes a lens, the diopter adjusting optical system changing an emittance or convergence of a luminous flux of laser light and changing a depth of a focal point inside the medium with a diffraction limit kept.

5. The objective optical system according to claim 4, wherein the diopter adjusting optical system includes one of a focal length variable lens, a transmission spatial light modulator, a deformable mirror, and a reflection spatial light modulator.

6. The objective optical system according to claim 4, wherein the objective lens has a numerical aperture of 0.6 to 0.9.

7. The objective optical system according to claim 4, further comprising an optical system arranged between the diopter adjusting optical system and the objective lens, the optical system relaying such that the diopter adjusting optical system is conjugate with the objective lens.

8. The objective optical system according to claim 4, further comprising a spherical aberration adjustment mechanism that moves partial lenses within the objective lens in a direction of an optical axis and thus adjusts a spherical aberration of the objective lens.

9. A laser machining device comprising an objective optical system according to claim 4, the objective optical system condensing laser light to a focal point inside a medium.
